(19) United States
(12) Patent Application Publication
(10) Pub. No.: US 2003/0211329 A1
(43) Pub. Date: Nov. 13, 2003

(54) Sprayable laminate panel stiffener

(76) Inventor: Gary Fox, Racine, WI (US)

Correspondence Address: Stephen D. Harper, Law Department, Suite 200, 2500 Renaissance Blvd., Gulph Mills, PA, 19406, US

(21) Appl. No.: 10/141,380

(22) Filed: May 8, 2002

(51) Int. Cl. B32B 27/38

(52) U.S. Cl. 428/416; 428/413

(57) ABSTRACT

A two-layer laminate panel stiffener is provided that may be constructed by spraying the individual layers onto substrates, such as, automotive body panels. The two-layer laminate panel stiffener reduces the amount of time and cost required for such reinforcing structures because it consists of only two layers and also because it can be sprayed (or extruded) onto the substrate. Spray application enables the laminate to be applied to any shape of substrate. The first layer is a soft, compliant layer of material (or precursor to such a material) that is sprayed (or extruded) onto the substrate. The second layer comprising a formulation capable of providing a rigid or toughened stiffener material once cured is then sprayed (or extruded) over the first layer. The two-layer laminate panel stiffener prevents oil-canning of the substrate, as well as paint read-through. When the material used to form the rigid layer cures, the compliant layer helps to shield the substrate from the strains resulting from the shrinkage of the rigid layer because the compliant layer is not rigid after cure. The second layer is rigid after cure but its shrinkage strains are blocked from getting to the substrate by the compliant layer.

### BACKGROUND OF THE INVENTION

A. Field of the Invention

The present invention relates to a laminate stiffener for reinforcing thin rigid plates or sheets, and more particularly to a laminate panel stiffener for reinforcing motor vehicle components, and a method for assembling the laminate panel stiffener.

B. Description of the Related Art

In a number of applications, lightweight, high strength structural members are required. For example, in motor vehicles and aircraft as well as in various devices such as home appliances and the like, a number of composite materials have been proposed in the past as structural members, such as exotic light-weight alloys. In most applications, however, mass reduction must be balanced against the cost of the product to the consumer. Thus, there is a need for providing strength without significantly increasing material and labor costs. Moreover, reinforcement techniques are needed which can be easily adapted to existing geometries of structural parts, thereby obviating any requirement for fundamental design changes.

A typical motor vehicle door includes an outer skin or panel of thin steel or aluminum. The outer panel is attached to structural members and, along with an inner door panel, defines a space or cavity into which a moveable window retracts. In addition to the moveable window a number of latch fixtures and window actuators are located in this door space.

Due to the large surface area of the outer panel and the thinness of the sheet metal normally used, a phenomenon such as “oil-canning” may occur. As applied to an outer door panel, oil-canning refers to the tendency of the door panel to flex from its desired position (often typically bowed) to a second, undesired position in which the outer panel is deformed or flexed inwardly toward the inner door panel. This movement may occur in response to slight pressures on the outer panel such as the weight of an individual leaning against the vehicle.

Although the oil-canning may be momentary with the panel immediately returning to its original configuration, it may be permanent and, moreover, may cause a crease to form in the panel coating. As will be understood by those in the art, creases of this kind must be removed in a body shop or the like and require that the panel be repainted.

While a number of side impact beams are known, these beams focus on the structural integrity of the motor vehicle in a crash and are not directed to the oil-canning problem. For example, a side impact beam for a vehicle door proposed in U.S. Pat. No. 4,978,562 comprises an open channel-shaped metal member having a longitudinal cavity which is filled with a thermoset or thermoplastic resin-based foam material core. The core is disposed in the mid-span of the beam, but does not adhere to the sides of the beam. The core may include hollow glass microspheres in order to decrease density and thus weight.

Although filling large volumes of a door cavity with a foam prevents oil-canning, such an approach also significantly increases mass and thus weight, which, of course, is an undesirable feature. In addition, large volumes of foam contribute significantly to cost. A large foam core often creates an unwanted heat sink. Although increasing the metal gauge of the door panel or adding localized thick metal reinforcements will increase stiffness, as the metal thickness increases so does the weight of the door, which is undesirable.

One conventional method of stiffening outer automotive body panels involves placing a sheet of thermosettable polymer on the inside of a panel and then heat curing the thermosettable polymer in a paint oven. The conventional heat cured stiffener is typically applied to the panel as a wallpaper sheet type appliqué. The appliqué is typically provided as a double layer sheet. The main layer is a thermosettable polymer layer, while the second layer is a backing layer which covers the main layer. The backing layer typically consists of fiberglass cloth, metal screen, or foil.

Alternatively, the thermosettable polymer layer may be sprayed-on as a single polymer layer without a backing. The polymer layer is generally 0.020 to 0.100 inches thick. Examples of such sprayable single polymer layers are shown in U.S. Pat. No. 4,751,129 and U.S. Pat. No. 5,712,317.

When the vehicle doors are painted, there often is a problem with paint read-through once the outer metal body panel stiffened with the thermosettable polymer sheet has been heat cured. That is, the painted outer surface of the vehicle door becomes somewhat distorted as a result of the shrinkage of the thermosettable polymer which takes place upon curing, thereby marring the appearance of the painted door. This is particularly true in the conventional single polymer layer methods. Thus, it would be desirable if techniques could be provided to eliminate or reduce the paint read-through problem.

One solution to the paint read-through problem is provided in U.S. patent application Ser. No. 09/437,395, filed Nov. 10, 1999, and assigned to the Assignee of the present application, Henkel Corporation. As disclosed in Ser. No. 09/437,395, a laminate useful for reinforcing or stiffening body panels is provided which includes three polymeric layers. The laminate is formed separate, and then applied to a substrate such as a body panel. One of the polymeric layers is a compliant layer comprised of flexible, pliable polymer which is adhered to the substrate or structural member being reinforced, using a reactive thermosettable adhesive comprised of at least one polyol, at least one epoxy resin, and at least one polyisocyanate. Thermosettable adhesives of this type have been found to provide a high strength bond between the laminate and the substrate, even where the substrate surface is coated with oil or other greasy substances. A rigid layer comprised of a thermoset resin is secured to the other side of the compliant layer. The rigid layer improves the resistance of the substrate against bending or flexing. A carrier, such as a foil or fiberglass backing, is then secured to the outer surface of the rigid layer.

Another solution to the paint read-through problem is provided in International Patent Application No. WO 99/50057, published Oct. 7, 1999, and assigned to the Assignee of the present application, Henkel Corporation. As disclosed in WO 99/50057, a tri-laminate stiffener includes a compliant layer that is applied to a substrate such as a door panel. A rigid foam layer is secured to the other side of the compliant layer, but WO 99/50057 does not disclose specific methods for applying this rigid foam layer. A carrier, such as a foil or fiberglass backing, may be secured to the outer surface of the rigid layer.

Unfortunately, the laminate disclosed in Ser. No. 09/437,395 is applied as a wallpaper sheet type applique and consists of three layers, both of which increase the time and cost involved in installation. Similarly, the tri-laminate disclosed in WO 99/50057 consists of three layers.

Accordingly, there is a need for a lightweight door panel stiffener which is economical to produce and install, prevents oil-canning and paint read-through, and provides structural reinforcement.

### SUMMARY OF THE INVENTION

The present invention solves the needs of the related art by providing a two-layer laminate panel stiffener that may be assembled by spraying (or extrusion) onto substrates, such as, for example, automotive body panels. The two-layer laminate panel stiffener reduces the amount of time and cost required for such reinforcing structures because it consists of only two layers and also because the two layers can be sprayed (or extruded) onto the substrate. The first layer is a soft, highly-elastic layer of material that is sprayed (or extruded) onto the substrate. A precursor capable of forming the second layer of rigid or toughened stiffener material is then sprayed (or extruded) over the first layer. Once activated, the two-layer laminate panel stiffener of the present invention prevents oil-canning of the substrate, as well as paint read-through. Spray application of layers used to form the two-layer laminate panel stiffener enables the present invention to be used with substrates having any geometry.

The first layer preferably includes a material capable of adhering to the substrate and the second rigid layer, without sagging or deforming, and capable of providing a relatively soft, elastic layer. The second, rigid layer preferably includes a material that improves the resistance of the substrate against bending or flexing once cured or crosslinked, and readily adheres to the first layer, without sagging or deforming. The two-layer laminate panel stiffener of the present invention has the further advantage of dampening acoustic and other vibrations, thereby reducing the level of noise in the interior of a vehicle having panels reinforced with such stiffeners.

The spraying process of the present invention enables precursor layers of the two-layer panel stiffener to be economically and easily applied to the surface of any geometrically-shaped substrate. In contrast, conventional wallpaper sheet type appliqués need to be redesigned for each geometrically-shaped substrate, significantly increasing the costs of the conventional process. Spray application can be performed with various methods depending upon the viscosity, rheology, and thickness of the first and second layers, the type of cure required, and the overall production process requirements. If materials making up the first and second precursor layers are fluid enough they can be spray applied, with or without air, or swirl sprayed.

In accordance with the purpose of the invention, as embodied and broadly described herein, the invention comprises a laminate stiffener for a substrate, including: a compliant layer comprising a flexible pliable polymer or precursor thereof, said compliant layer being formed by spraying on a surface of said substrate; and a sprayable rigid layer precursor comprising a thermosettable resin, said sprayable rigid layer precursor being formed on a surface of said sprayable compliant layer, and said compliant layer being sandwiched between said sprayable rigid layer precursor and said substrate. Once activated by heating or other such method of inducing curing, the rigid layer precursor forms a rigid layer which imparts stiffness and strength to the substrate, while the compliant layer bonds the rigid layer to the substrate while at the same time minimizing the amount of paint read-through which would occur in the absence of the compliant layer.

Further in accordance with the purpose of the invention, as embodied and broadly described herein, the invention comprises a laminate stiffener for a substrate, including: a sprayable compliant layer precursor comprising at least one vulcanizable diene rubber, said compliant layer precursor being formed by spraying on a surface of said substrate; and a rigid layer precursor comprising an epoxy resin, said rigid layer precursor being formed on a surface of said compliant layer precursor, and said compliant layer precursor being sandwiched between said rigid layer precursor and said substrate. The laminate stiffener is heated or otherwise treated so as to induce vulcanization of the vulcanizable diene rubber (thereby forming the desired compliant layer) and to induce curing of the epoxy resin (thereby forming the desired rigid layer).

Still further in accordance with the purpose of the invention, as embodied and broadly described herein, the invention comprises a method of reinforcing a substrate, including: spraying a compliant layer comprising a flexible pliable polymer or precursor thereof on a surface of said substrate; spraying a rigid layer precursor comprising a thermosettable resin on a surface of said compliant layer, wherein said compliant layer is sandwiched between said rigid layer precursor and said substrate; and heating the rigid layer precursor under conditions effective to cure the thermosettable resin (and the flexible pliable polymer precursor, if such precursor has been utilized).

### DETAILED DESCRIPTION OF EMBODIMENTS OF THE INVENTION

The following detailed description does not limit the invention. Instead, the scope of the invention is defined by the appended claims and equivalents thereof.

Except in the claims and the operating examples, or where otherwise expressly indicated to the contrary, all numerical quantities in this description indicating amounts of material or conditions of reaction and/or use are to be understood as modified by the word “about” in describing the broadest scope of the invention. Practice within the numerical limits stated is generally preferred, however. Also, throughout the description and claims, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; specification of materials in ionic form implies the presence of sufficient counterions to produce electrical neutrality for the composition as a whole, and any counterions thus implicitly specified preferably are selected from among other constituents explicitly specified in ionic form, to the extent possible; otherwise such counterions may be freely selected, except for avoiding counterions that act adversely to the objects of the invention; and the term “mole” and its variations may be applied to ionic, chemically unstable neutral, or any other chemical species, whether actual or hypothetical, that is specified by the type(s) of atoms present and the number of each type of atom included in the unit define, as well as to substances with well defined neutral molecules.

The present invention is drawn broadly to a two-layer laminate panel stiffener that may be constructed by spraying on substrates, such as, for example, automotive body panels. The first layer is a material that is preferably sprayed (but may be extruded) onto the substrate and which provides a compliant, soft, highly elastic layer, either directly or following some further treatment (e.g., curing of a vulcanizable rubber present in the applied material). The second layer of material is then preferably sprayed (but may be extruded) over the first layer. The second layer contains a thermosettable resin, which is cured to form a rigid layer.

When the thermosettable resin used to form the rigid second layer cures, the compliant layer helps to shield the substrate from the strains resulting from the shrinkage of the rigid layer because the compliant layer is not rigid after cure. The second layer is rigid after cure but its shrinkage strains are blocked from getting to the substrate by the compliant layer.

The compliant layer absorbs shrinkage strains due to the cure of the rigid layer. Large shrinkage strains of the rigid layer are not transferred to the substrate, but yet the rigid layer adequately stiffens the substrate. Typical layer thicknesses are from about 0.1 to about 6 millimeters (mm) (preferably, about 1 to about 4 mm) for the compliant layer, and about 0.1 to about 10 mm (preferably, about 0.5 to about 4 mm) for the rigid layer. Any suitable materials may be used for the compliant and rigid layers. Both layers should be compatible in chemistry and good adhesion between the layers should exist once the layers are cured, however, otherwise the properties of the cured finished laminate will be compromised. The specific materials are not critical provided they function in the intended manner, namely, in that the first layer will be compliant while the second layer will be rigid once cured, with both layers being easily and quickly applied (e.g., sprayed) onto a substrate.

### A. The First Laminate Layer (The Compliant Layer)

The first laminate layer of the present invention is the compliant layer. The compliant layer is comprised of a flexible, pliant polymer and/or reactants capable of forming a flexible, pliant polymer once reacted. The chemical composition of the polymer is not believed to be particularly critical and any of a number of different rubbery, elastic (elastomeric) or viscoelastic materials known in the art may be selected for this purpose. The polymer may be thermoplastic in character, although generally it will be preferred to employ a thermosettable polymer which cross-links and cures when the laminate is heated. In one desirable embodiment of the invention the flexible, pliant polymer is foamed. Foaming may be achieved using physical blowing agents such as volatile hydrocarbons and halogenated hydrocarbons. Chemical blowing agents and encapsulated physical blowing agents activated by heat, such as those discussed in connection with the rigid layer of the present invention below, may also be used to advantage. Selection of the blowing agent(s) and curing agent(s) should be coordinated such that foaming and curing take place within approximately the same temperature range.

Materials suitable for use in forming the compliant layer include, but are not limited to, natural rubber, neoprene rubber, isoprene rubber, butadiene rubber, styrene-butadiene rubber and other butadiene rubbers, brominated isobutyleneisoprene rubber, chloroprene rubber, butadiene-acrylonitrile rubber, isopreneacrylonitrile rubber and other diene-based specialty rubbers, butyl rubber, ethylene-propylene rubbers, acrylic rubbers, halogenated butyl rubbers, urethane rubbers, hydrin rubbers, ethylene-acrylate copolymers, ethylene-propylene-diene rubbers, polysulfide rubbers, silicone rubbers, fluorine rubbers, polyethylene chloride and combinations thereof. Liquid, solid, and mixtures of liquid and solid rubbers may be utilized. Diene rubbers, i.e., polymers obtained by polymerization of conjugated dienes such as butadiene or isoprene (either alone or in combination with other comonomers) are particularly preferred for use. The rubbers may contain functional groups such as hydroxy, amino, carboxyl, carboxylic anhydride, or epoxy groups, which may be terminal and/or pendent to the polymer backbone. Such polymers may be incorporated into the laminate in vulcanized form prior to application of the laminate to the substrate and curing of the adhesive composition and thermosettable resin. Alternatively, such polymer may be unvulcanized or partially unvulcanized when the laminate is initially constructed, then cross-linked or otherwise cured at the same time as the thermosettable resin in the rigid layer precursor to provide the laminate in its final form containing the rigid layer derived from the thermosettable resin and the compliant layer derived from the polymer. Any of the conventional cross-linking or vulcanizing agents known in the art may be used for such purpose including, for example, peroxides, sulfur (which may be used in combination with vulcanization accelerators) and the like.

The flexible, pliant polymer should be selected to be a material which prior to vulcanization or cross-linking is capable of easily changing shape and following the shape or contours of the substrate to give close contact between the laminate and the substrate, even if the substrate surface to which the laminate is to be applied is uneven or contains protrusions or recessed areas. Accordingly, the viscosity or elasticity of the polymer should not be excessive. This will permit the compliant layer to be readily conformed to the substrate surface. One advantage of using a foamable polymer for the compliant layer, however, is that any gaps which might exist between the compliant layer and the substrate surface when the compliant layer is initially applied will tend to be filled as the polymer expands during foaming. At the same time, however, care should be taken not to utilize and/or maintain a polymer which has a viscosity that is too low, since this may make it difficult to attain the desired thickness of the compliant layer. Preferably, the composition used to form the compliant layer does not cold flow and is thixotropic by design at normal handling and storage temperatures (e.g., 20° C.-30° C.). Thixotropic agents (e.g., fumed silica, calcium carbonate, calcium oxide, finely divided silica) are preferably used to modify the flow properties of the compliant layer. The use of such thixotropic agents is preferable to permit or enhance spray application of the compliant layer, such that the compliant layer is fluid when agitated or otherwise subjected to an external force but becomes non-fluid (e.g., gelled or coagulated) in the absence of such agitiation or external force.

The compositions used to form the compliant layer may contain, in addition to one or more vulcanizable or cross-linkable rubbers or elastomers, blowing agents, and vulcanizing/cross-linking agents, other components such as, for example, thermoplastic polymers (e.g., polyethylene, ethylene/vinyl acetate copolymer, polyvinyl chloride, ethylene/propylene copolymer), colorants (e.g., carbon black), fillers and thixotropic agents (e.g., fumed silica, calcium carbonate, calcium oxide, finely divided silica), thermosettable resins other than the vulcanizable rubbers (e.g., phenolic resins, epoxy resins), diluents or extender oils (e.g., petroleum hydrocarbons), plasticizers (e.g., phthalate esters), tackifiers, stabilizers, and the like. Relatively high loadings of filler can improve the sound dampening characteristics of the laminate. Adjusting the glass transition temperature to approximately room temperature (e.g., 20° C.-25° C.) by the use of plasticizers may further enhance the ability of the laminate to suppress acoustic vibrations. In one preferred embodiment of the invention, the composition serving as the precursor to the compliant layer is a foamable, vulcanizable material corresponding to the following formulation:

| Component | Wt. % |
|---|---|
| Vulcanizable Diene-Based Rubber(s) | 5-50 |
| Thermoplastic Polymer(s) | 0.5-50 |
| Colorant(s) | 0.1-5 |
| Filler(s)/Thixotropic Agent(s) | 10-50 |
| Other Thermosettable Resin(s) | 1-25 |
| Vulcanization and Curing Agent(s) | 0.05-5 |
| Blowing Agent(s) | 0-5 |

Such compositions are well known to workers in the field and may be readily obtained from commercial sources, such as Multiseal Inc. of Evansville, Ind. Materials suitable for use in preparing the compliant layer of the present invention are described, in the following patents and applications, each of which is incorporated herein by reference in its entirety, except where inconsistent with the express teachings of the present invention: International Patent Application No. WO 96/23040; U.S. Pat. Nos. 5,356,994, 5,256,738, 4,600,745, 4,824,512, and 5,149,742; European Patent Nos. EP 097,394, EP 309,903, EP 496,864; and Canadian Patent No. 2,000,569.

### B. The Second Laminate Layer (The Rigid Layer)

The second laminate layer of the present invention is the rigid layer. In one embodiment of the invention, the rigid layer is obtained by curing of a thermosettable resin which in its uncured state is relatively soft and pliable. This property is advantageous since it enables the two-layer laminate to be assembled by spray application of each layer to a substrate having any configuration, without changing the properties of the two-layer laminate. The two-layer laminate thereby can be easily spray applied to conform closely to the contours of the substrate. Upon curing, however, the thermosettable resin cross-links to provide the stiffness desired in the rigid layer. At the same time, the uncured thermosettable resin formulation should be sufficiently viscous, thixotropic or solid such that the integrity of the laminate prior to curing is maintained, thereby permitting the uncured laminate to be readily handled and subjected to further treatments such as, for example, immersion in a phosphating bath. A fully liquid thermosettable resin having a low viscosity at normal storage or handling temperatures would enable spray application. Preferably, the uncured resin formulation does not cold flow and is thixotropic by design at normal handling and storage temperatures (e.g., 20° C.-30° C.). Where low viscosity liquid or semi-liquid components are utilized in the formulation, it will generally be desirable to also incorporate solid fillers and/or thixotropic agents and/or thickeners in order to achieve the desired consistency to enable or enhance spray application of the second layer while maintaining the integrity of the laminate prior to curing.

While any thermosettable resin known in the art which can be cured to form a hard, stiff polymer may be utilized as a precursor to the rigid layer in the present invention, the use of epoxy resin-based systems is particularly preferred. Any of the thermosettable resins having an average of more than one (preferably, two or more) epoxy groups per molecule known or referred to in the art may be utilized.

Epoxy resins are described, for example, in the chapter entitled “Epoxy Resins” in the Second Edition of the Encyclopedia of Polymer Science and Engineering, Volume 6, pp. 322-382 (1986). Exemplary epoxy resins include polyglycidyl ethers obtained by reacting polyhydric phenols such as bisphenol A, bisphenol F, bisphenol AD, catechol, resorcinol, or polyhydric alcohols such as glycerin, sorbitol, 1,4-butanediol and polyalkylene glycols with haloepoxides such as epichlorohydrin; glycidylether esters obtained by reacting hydroxycarboxylic acids such as p-hydroxybenzoic acid or beta-hydroxy naphthoic acid with epichlorohydrin or the like; polyglycidyl ethers obtained by reacting polycarboxylic acids such as phthalic acid, tetrahydrophthalic acid or terephthalic acid with epichlorohydrin or the like; epoxidated phenolic-novolac resins (sometimes also referred to as polyglycidyl ethers or phenolic novolac compounds); epoxidated polyolefins; glycidylated aminoalcohol compounds and aminophenol compounds, hydantoin diepoxides and urethane-modified epoxy resins. Mixtures of epoxy resins may be used if so desired. For example, mixtures of liquid (at room temperature), semi-solid, and/or solid epoxy resins can be employed. Any of the epoxy resins available from commercial sources are suitable for use in the present invention.

Preferably, the epoxy resin has an epoxide equivalent molecular weight of from about 150 to 1,000.The use of epoxy resins based on glycidyl ethers of bisphenol A is especially advantageous. The epoxy resin(s) preferably have an average of about 2 epoxy groups per molecule, although higher functionality epoxy resins may be used where a higher degree of cross-linking is desired. The epoxy resins or resins should be selected so as to provide the desired combination of properties in both the as applied laminate and the final cured laminate.

The hardening of the thermosettable epoxy utilized in the present invention may be accomplished by the addition of any chemical materials known in the art for curing such resins. Such materials are referred to herein as “curatives”, but also include the substances known to workers in the field as curing agents, hardeners, activators, catalysts or accelerators. While certain curatives promote epoxy resin curing by catalytic action, others participate directly in the resin and are incorporated into the thermoset polymeric network formed by condensation, chain-extension and/or cross-linking of the epoxy resins.

It is particularly desirable to employ at least one curative which is a nitrogen-containing compound. Such curatives (along with other curatives useful for hardening epoxy resins) are described in the chapter in the Encyclopedia of Polymer Science and Engineering referenced herein. Latent thermally triggered curatives (i.e., compounds which initiate curing of the epoxy resin only when heated above a certain temperature) are especially preferred. Suitable nitrogen-containing compounds useful as curatives include amino compounds, amine salts, and quaternary ammonium compounds. Particularly preferred types of nitrogen-containing compounds include amine-epoxy adducts and guanidines. In one desirable embodiment of the invention, two or more different types of these nitrogen-containing compounds are used in combination.

Amine-epoxy adducts are well-known in the art and are described, for example, in U.S. Pat. Nos. 3,756,984, 4,066,625, 4,268,656, 4,360,649, 4,542,202, 4,546,155, 5,134,239, 5,407,978, 5,543,486, 5,548,058, 5,430,112, 5,464,910, 5,439,977, 5,717,011, 5,733,954, 5,789,498, 5,798,399 and 5,801,218, each of which is incorporated herein by reference in its entirety except where inconsistent with the teachings of the present invention. Such amine-epoxy adducts are the products of the reaction between one or more amine compounds and one or more epoxy compounds. Carboxylic acid anhydrides, carboxylic acids, phenolic novolac resins, water, metal salts and the like may also be utilized as additional reactants in the preparation of the amine-epoxy adduct or to further modify the adduct once the amine and epoxy have been reacted. Preferably, the adduct is a solid which is insoluble in the epoxy resin component of the present invention at room temperature, but which becomes soluble and functions as an accelerator to increase the cure rate upon heating. While any type of amine could be used (with heterocyclic amines and/or amines containing at least one secondary nitrogen atom being preferred), imidazole compounds are particularly preferred. Illustrative imidazoles include 2-methyl imidazole, 2,4-dimethyl imidazole, 2-ethyl-4-methyl imidazole, 2-phenyl imidazole and the like. Other suitable amines include, but are not limited to, piperazines, piperidines, pyrazoles, purines, and triazoles.

Any kind of epoxy compound can be employed as the other starting material of the adduct, including monofunctional, bifunctional, and polyfunctional epoxy compounds such as those described previously with regard to the epoxy resin component. Suitable amine-epoxy adducts are available from commercial sources such as Ajinomoto, Inc., Shell, Pacific Anchor Chemical Company, and the Asahi Chemical Industry Company Limited. The products sold by Ajinomoto under the trademarks AJICURE PN-40 and AJICURE PN-23 are especially preferred for use in the present invention.

Dicyandiamide (sold commercially by Air Products under the trademark DICY) is also a particularly preferred curative, although other guanidine compounds may also be utilized. The curative system may also comprise one or more ureas, either alone or in combination with other types of curatives (especially guanidines such as dicyandiamide). Suitable ureas include alkyl and aryl substituted ureas. Many such ureas are available commercially, for example, N,N′-dimethyl urea, which is sold under the trademark AMICURE UR by Air Products. Imidazoles such as 2-ethyl-4-methyl imidazole may also be used as curatives.

The curative system (i.e., the specific curatives and the amounts of such curatives) should be selected such that it does not catalyze curing of the epoxy resin in the laminate to any significant extent under typical storage conditions over an extended period of time. Preferably, the components of the curative system are adjusted such that the epoxy resin formulation retains a workable consistency for more than two weeks in storage at 130° F. (54° C.) and does not expand in volume or decrease in specific gravity under such conditions to an unacceptable extent, yet cures within 10 minutes upon being heated at 150° C. or higher to provide a rigid layer comparable in properties to those of a rigid layer obtained from a freshly prepared composition.

In a particularly desirable embodiment, the rigid layer is foamed. Selection of the blowing agent or blowing agents to be used in the present invention is not believed to be particularly critical, although chemical blowing agents in general (particularly those activated by heating) are preferred over physical blowing agents. Encapsulated blowing agents may also be utilized. Any of the chemical blowing agents known in the art may be employed, with azodicarbonamide (also sometimes referred to as 1,1′-azobisformamide, AZDC, or ADC) and sulfonyl hydrazides providing particularly good performance.

Azodicarbonamide is available from a number of commercial sources. For example, it is sold under the trademark UNICELL by Doug Jin Chemical of South Korea, and under the CELOGEN trademark by Uniroyal Chemical. “Activated” or “modified” forms of azodiacarbonamide may be used to advantage. In some formulations, it may be desirable to also use a blowing agent accelerator (activator) so as to lower the temperature at which release of the gas from the blowing agent takes place. Typically, about 0.05% to about 2% blowing agent accelerator based on the overall weight of the thermosettable resin formulation is employed, although the optimum amount will, of course, vary depending upon the accelerator selected, the amount of blowing agent, cure temperature and other variables. Excess accelerator should not be present in the thermosettable resin formulation, however, since the storage stability may be undesirably compromised.

It is especially desirable to include one or more glass fillers in the epoxy resin formulation which is a precursor to the rigid layer, as such fillers have been found to impart useful characteristics to the resulting rigid layer (especially where it is to be used to reinforce or stiffen a substrate). For example, hollow glass microspheres may be added to reduce the density of the rigid layer and thus the overall weight of the reinforced substrate while maintaining good stiffness and strength. Commercially available glass microspheres (sometimes also referred to as glass microballoons or microbubbles) include the materials sold by Minnesota Mining and Manufacturing under the trademark SCOTCHLITE, with suitable grades including those sold under the designations B38, 015, K20 and VS 5500.The glass microspheres preferably have diameters in the range of from about 5 to about 200 micrometers (preferably, from about 5 to about 70 micrometers). The crush strength of the hollow glass microspheres may be selected in accordance with the desired characteristics of the cured laminate or reinforced substrate having the cured laminate adhered thereto. Microspheres having a crush strength in excess of 500 psi are typically employed, however. Glass fiber is another preferred type of glass filler, since it helps increase the strength and stiffness of the resulting rigid layer. The glass fiber may be chopped, milled or in other physical forms.

Other types of fillers may also be optionally present in the epoxy resin formulation. Any of the conventional inorganic or organic fillers known in the thermosettable resin art may be used including, for example, fibers other than glass fibers (e.g., wollastinite fibers, carbon fibers, ceramic fibers, and aramid fibers), silica (including fumed or pyrogenic silica, which may also function as a thixotropic or rheological control agent), calcium carbonate (including coated and/or precipitated calcium carbonate, which may also act as a thixotropic or rheological control agent, especially when it is in the form of fine particles), alumina, clays, sand, metals (e.g., aluminum powder), microspheres other than glass microspheres (including thermoplastic resin, ceramic and carbon microspheres, which may also be solid or hollow, expanded or expandable), macrospheres, and any of the other organic or inorganic fillers known in the epoxy resin field.

Other optional components include diluents (reactive or non-reactive) such as glycidyl ethers, glycidyl esters, acrylics, solvents, and plasticizers, toughening agents and flexibilizers (e.g., aliphatic diepoxides, polyaminoamides, liquid polysulfide polymers, rubbers including liquid nitrile rubbers such as butadieneacrylonitrile copolymers, which may be functionalized with carboxyl groups, amine groups or the like), adhesion promoters (also known as wetting or coupling agents, e.g., silanes, titanates, zirconates), colorants (e.g., dyes and pigments such as carbon black), stabilizers (e.g., antioxidants, UV stabilizers), and the like.

The epoxy resin formulations used to form the rigid layer of the laminate of the present invention preferably contain the above-discussed components in the following amounts (expressed as a percentage of the total weight of the epoxy resin formulation).

| Component | Preferred | More Preferred |
|---|---|---|
| Epoxy Resin(s) | about 35-85 | about 40-70 |
| Blowing Agent(s) | about 0.1-5 | about 0.5-3 |
| Curative(s) | about 0.1-10 | about 1-8 |
| Filler(s) | about 5-60 | about 20-45 |
| Adhesion Promoter(s) | up to about 2 | about 0.001-0.5 |
| Colorant(s) | up to about 2 | about 0.01-1 |
| Toughening/Flexibilizing Agent(s) | up to about 15 | about 0.5-10 |
| Blowing Agent Accelerator(s) | up to about 3 | about 0.05-2 |
| Stabilizer(s) | up to about 2 | about 0.01-1 |

Preferably, epoxy resin is present in an amount which is greater than the amount of any of the other components in the epoxy resin formulation. The above-described ingredients may simply be combined and mixed to form the epoxy resin formulation using any of the processing methods known in the epoxy resin art.

Further details concerning preferred thermosettable resin formulations suitable for use in the present invention may be found in the following patents and applications, each of which is incorporated herein by reference in its entirety except where inconsistent with the teachings of the present invention: U.S. Pat. Nos. 4,751,249, 4,769,391, 4,836,516,4,908,930, 4,853,270, 4,861,097, 4,901,500, 4,922,596, 4,923,902, 4,995,545, 4,978,562, 5,124,186, 5,575,526, 5,884,960, 5,755,486, and 5,888,600; European Patent Publication Nos. EP 893,331, EP 891,918, and EP 893,332, and International (PCT) Patent Publication Nos. WO 97/43501 and WO 99/08854.

### C. The Process of Forming the Laminate Panel Stiffener

The two-layer laminate panel stiffener of the present invention may be assembled using any suitable method. For example, the composition employed to form the compliant layer may be extruded as a thin sheet onto a conveyor belt. The extruded thin sheet may then be passed under the die of a second extruder and the thermosettable resin formulation being used to form the rigid layer extruded as a second thin sheet onto the first thin sheet.

The curing and foaming agents employed may be varied as needed to enable the laminate panel stiffener to be “activated” at a particular temperature or within a particular temperature range. It will be particularly advantageous and convenient to select the components of the different layers such that the laminate is fully cured and/or foamed under typical paint oven conditions (e.g., 120° C. to 220° C. for 5 to 90 minutes). Reinforcement of panels using the laminate panel stiffener of this invention thus may be readily integrated into standard vehicle production lines.

Preferably, however, the components of the two-layer laminate panel stiffener of the present invention are spray applied to the substrate. Spray application enables the two-layer laminate to be easily and economically applied to a substrate having any geometry. Spray application can be performed with various methods depending upon the viscosity, rheology, and thickness of first and second layers, the type of cure required, and the overall production process requirements. Preferably, materials making up the first and second layers are fluid enough so that they can be spray applied at pressures between 200 and 5000 pounds per square inch (psi), with or without air-assisted spraying. The materials may be heated if needed to reduce viscosity, although care should be taken to avoid premature curing or foaming of the materials. In the case where any one or both materials are too viscous to atomize they can be swirl sprayed or flat extruded directly onto the substrate, or onto the first layer if the second layer is being applied. As used herein the term “swirl sprayed” refers to high pressure extrusion with mechanical or air-assisted swirling of the material to form a flat, wide bead pattern. For example, a bead of the composition being applied may be extruded from a discharge bore formed in a nozzle plate mounted to the nozzle of a dispenser. The extruded bead may then be impinged by air jets emitted from bores formed in the nozzle plate to stretch the extruded bead to form a thinner stream of the composition, which is then twisted or swirled as it is deposited on the substrate. As used herein, the term “flat extruded” refers to extrusion where the width of the extruded material is considerably greater than the thickness. In some but not all cases, one or both of the first and second layers may need to be fully or partially cured (“pre-gelled”) by an energy-based or chemically-based method to protect the integrity of the layered material during industrial cleaning or coating processes.

Even though the spray laminate of the present invention may be manually applied (e.g., hand sprayed) or automatically applied (e.g., robotically sprayed), both types of application methods require a material delivery system that matches the pre-cure characteristics of the first and second layers. For example, a product sold by The Surface Technology Division of Henkel Corporation under the trademark TEROSTAT 06-1272 may be spray applied as the first layer; and another product sold by The Surface Technology Division of Henkel Corporation under the trademark TEROKAL 5057-15 may be spray applied as the second layer.

TEROSTAT 06-1272 is a high rubber-based product that is non-expanding and provides a weld-through sealant (a weld-through sealant may be used to prevent rust from entering a welded area). TEROSTAT 06-1272 has enhanced shear adhesion and gas resistance and is highly wash-off resistant. TEROSTAT 06-1272 includes pumpable mastics, profile tapes, and die cuts that make up a family of rubber-based adhesives for white body applications. TEROSTAT 06-1272 can typically be engineered for individual requirements, and is commonly a low to zero Volatile Organic Compound (VOC). It offers good corrosion resistance, high elasticity, and bonding characteristics, without read-through. TEROSTAT 06-1272 would be spray applied directly to the metal substrate (e.g., door panel inner) as the first layer because of its excellent resistance to read-through.

TEROKAL 5057-15 is a high viscosity, heat curing, coating material based on epoxy resins (described previously with respect to the second layer). TEROKAL 5057-15 has good sag and wash-off resistance to wash and phosphating solutions. TEROKAL 5057-15 is free of solvents and polyvinyl chloride (PVC), and is typically cured in an oven. TEROKAL 5057-15 would be spray applied as the second layer, directly over the entire surface of the first layer, to stiffen the substrate once cured.

Preferably, both the first and second layers are dispensed using a pumping system directly connected to a bulk container (e.g., 55-gallon drums). Such a pumping system may include a high-pressure ratio pump having a recommended ratio of 55:1 or greater. In order to use lower pressure ratio pumps, the pumping system design should minimize flow restrictions. Flow restrictions occur when headers, hoses, and/or nozzles are too small for the application. TEROSTAT 06-1272 and TEROKAL 5057-15 may be applied with an air-assisted application system (swirl spray) that uses a supporting air cone or mechanically-rotating swirl spray. With such techniques the material is not torn into particles (which may occur with airless spraying), but rather is evenly distributed, resulting in a planar coating of the first and second layers without overspray. Since TEROSTAT 06-1272 and TEROKAL 5057-15 have very good wash-off characteristics, there is no need for pre-gelling.

A substrate coated with the first and second layers of the present invention, may pass through washing, phosphating, and electrochemical baths, and subsequently cure in an electrochemical oven for generally 30 minutes at 170° C. Although the thicknesses of the first and second layers may vary, the final cured product may have, for example, a TEROSTAT 06-1272 first layer having a thickness of approximately 2 millimeters (mm), and a TEROKAL 5057-15 second layer having a thickness of approximately 2 mm. The two-layer laminate stiffener of the present invention provides a door panel having greatly enhanced stiffness, but also excellent external appearance due to the minimization of paint read-through. In high volume production applications, the process of forming the laminate panel stiffener of the present invention provides significant cost savings over conventional laminates that are formed separately from a door and applied as a “patch”. Specifically, the present invention eliminates the manual labor required to handle and apply conventional laminates to the door. The process also enables the two-layer laminate panel stiffener to be applied to a substrate having any size, shape, or dimension. This prevents the problems encountered by conventional wallpaper sheet type appliqués, which need to be redesigned for each new substrate geometry.

It will be apparent to those skilled in the art that various modifications and variations can be made in the laminate panel stiffener of the present invention without departing from the scope or spirit of the invention. For example, the laminate panel stiffener of the present invention is useful for reinforcing panels used in industries other than the automotive industry, such as, appliances, furniture, aircraft, farm machinery, construction equipment and the like. In addition to vehicle door panels, the present invention may be used to reinforce other types of panels such as hood and trunk lids.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A laminate stiffener for a substrate, comprising:
a compliant layer comprising a flexible pliable polymer or precursor thereof, said compliant layer being formed by spraying on a surface of said substrate; and
a rigid layer precursor comprising a thermosettable resin, said rigid layer precursor being disposed on a surface of said sprayable compliant layer by spraying, and said compliant layer being sandwiched between said rigid layer precursor and said substrate.

2. A laminate stiffener as recited in claim 1, wherein the thermosettable resin comprises an epoxy resin.

3. A laminate stiffener as recited in claim 1, wherein said rigid layer precursor is foamable.

4. A laminate stiffener as recited in claim 1, wherein said compliant layer comprises an ethylene/vinyl acetate copolymer.

5. A laminate stiffener as recited in claim 1, wherein said compliant layer is foamable.

6. A laminate stiffener as recited in claim 1, wherein said substrate comprises metal.

7. A laminate stiffener as recited in claim 1, wherein said substrate comprises steel.

8. A laminate stiffener as recited in claim 1, wherein said substrate is a vehicle panel.

9. A laminate stiffener for a substrate, comprising:
a compliant layer precursor comprising at least one vulcanizable diene rubber, said compliant layer precursor being disposed on a surface of said substrate by spraying; and
a rigid layer precursor comprising an epoxy resin, said rigid layer precursor being disposed on a surface of said compliant layer precursor by spraying, and said compliant layer precursor being sandwiched between said rigid layer precursor and said substrate.

10. A laminate stiffener as recited in claim 9, wherein said rigid layer precursor is foamable.

11. A laminate stiffener as recited in claim 9, wherein said compliant layer precursor is foamable.

12. A laminate stiffener as recited in claim 9, wherein said substrate comprises metal.

13. A laminate stiffener as recited in claim 9, wherein said substrate comprises steel.

14. A laminate stiffener as recited in claim 9, wherein said substrate is a vehicle panel.

15. A laminate stiffener as recited in claim 9, wherein said rigid layer precursor comprises at least one epoxy resin, at least one blowing agent, at least one curing agent, and hollow glass microspheres.

16. A method of reinforcing a substrate, comprising:
spraying a compliant layer comprising a flexible pliable polymer on a surface of said substrate;
spraying a rigid layer precursor comprising a thermosettable resin on a surface of said compliant layer, wherein said compliant layer is sandwiched between said rigid layer precursor and said substrate; and
curing the thermosettable resin to form a rigid layer.

17. A method of reinforcing a substrate as recited in claim 16, wherein said substrate comprises metal.

18. A method of reinforcing a substrate as recited in claim 16, wherein said substrate comprises metal sheeting.

19. A method of reinforcing a substrate as recited in claim 16, wherein the thermosettable resin comprises an epoxy resin.

20. A method of reinforcing a substrate as recited in claim 16, wherein said rigid layer is foamed.

21. A method of reinforcing a substrate as recited in claim 16, wherein said compliant layer further comprises at least one thermoplastic polymer.

22. A method of reinforcing a substrate as recited in claim 16, wherein said compliant layer comprises a vulcanizable diene rubber which is vulcanized by heating.

23. A method of reinforcing a substrate as recited in claim 16, wherein the compliant layer and the rigid layer precursor are manually spray applied.

24. A method of reinforcing a substrate as recited in claim 16, wherein the compliant layer and the rigid layer precursor are automatically spray applied.
